(19) United States
(12) Patent Application Publication
(10) Pub. No.: US 2015/0217420 A1
(43) Pub. Date: Aug. 6, 2015

(54) LENS RETAINING DEVICE FOR RETAINING A RAW LENS IN A PROCESSING MACHINE, AND METHOD FOR PROCESSING RAW LENSES

(71) Applicant: OptoTech Optikmaschinen GmbH, Wettenberg (DE)

(72) Inventor: Roland MANDLER, Heuchelheim (DE)

(21) Appl. No.: 14/511,367

(22) Filed: Oct. 10, 2014

(30) Foreign Application Priority Data
Feb. 3, 2014 (DE) 10 2014 101 266.6

(51) Int. Cl. B23Q 3/08; B24B 13/005

(52) U.S. Cl. CPC B23Q 3/088; B24B 13/005

(57) ABSTRACT

A processing machine that has a lens retaining device for retaining a raw lens in a processing machine has a tool mount for immobilizing the lens retaining device in a processing tool, and a workpiece mount for receiving a raw lens to be processed. The workpiece mount has a curved surface and is connected to the tool mount. An air channel extends from the tool mount to the curved surface of the workpiece mount. Furthermore, the workpiece mount has an adhesion element which at least to some extent forms the curved surface, wherein the adhesion element has adhesive properties on the curved surface. When processing raw lenses with such a retaining device, the raw lens is retained on the retaining device by means of the adhesion element and by generating a vacuum so that the raw lens is retained solely by means of the adhesion element during processing.

The invention relates to a lens retaining device for retaining a raw lens in a processing machine according to the preamble of claim 1 and a method for processing raw lenses according to claim 10.

For the processing of raw lenses, particularly in the mass production of individual spectacle glasses, they are reworked at least on one of two opposite lens surfaces. Frequently, the other side is formed with the final geometry and surface quality during production of the raw lens.

In order to be able to mechanically process the processing side of the raw lens by means of lathing, milling, grinding, and cutting, different lens retaining devices are known from the prior art.

DE 10 2008 023 093 A1, WO 2010/140958 A1, and U.S. Pat. No. 6,036,313 A each show a lens retaining device for retaining a raw lens in a processing machine. Each has a tool mount for immobilizing the lens retaining device in a processing tool. A workpiece mount for receiving a raw lens to be processed is provided, integral with the tool mount. The workpiece mount has a curved surface. For immobilizing the raw lens on the workpiece mount, a curing adhesive is provided.

DE 10 2008 023 093 A1 uses a UV adhesive, while WO 2010/140958 A1 and U.S. Pat. No. 6,036,313 A use a thermoplastic for adhesive purposes. The process of producing such solid connections between a raw lens and a lens retaining device is also called blocking.

Similar blocking methods use so-called alloys as curing adhesive. For example,

DE 694 02 900 T2 describes a blocking with alloys made of lead, cadmium, indium, bismuth, and tin alloys.

The blocking methods are disadvantageous because they take a relatively long time and the removal of the raw lenses is very elaborate. Furthermore, the blocking material, particularly an adhesive or thermoplastic, is not reusable. Therefore, this results in a great amount of, and to some extent hazardous, waste after each blocking process. During each blocking process, at least 1% to 2% of an alloy are lost. However, these small amounts are highly toxic heavy metals. Due to blocking in today's manufacture of spectacle glasses, it is estimated that worldwide several hundred tons of alloys are released unrestricted into the environment.

An alternative to the blocking methods are vacuum holders. In such vacuum holders, an air channel extends through a spindle-shaped tool mount to an outlet opening in a curved surface. The curved surface is in contact with the surface of a raw lens not to be processed. Generating a vacuum in the air channel causes the raw lens to be suctioned onto the curved surface during machine processing. For example, such a holder is described in DE 10 2012 101 581 A1.

A machine according to DE 10 2012 101 581 A1 is disadvantageous because the lens retaining device is firmly connected to the processing machine. Furthermore, for different lens radii, a different curved surface curvature must be provided for each radius. Therefore, a revolver with differently curved lens retaining devices is required. Moreover, according to DE 10 2012 101 581 A1, the raw lenses must be loaded without a holder onto the processing machine and also removed without a holder. If further processing steps are required on the spectacle glass away from the processing machine, a mounting of the raw lens on a lens retaining machine might once again be required.

Therefore, the problem addressed by the invention is that of overcoming the disadvantages of the prior art and to develop a lens retaining device and a method for retaining raw lenses in a simple manner during processing, wherein unnecessary processing steps and environmentally hazardous waste shall be prevented or at least reduced. Furthermore, the device and the method shall be cost-effective and reliable.

Main features of the invention are set out in the characterizing part of claim 1 and claim 10. Embodiments are subject matter of claims 2 to 9 and 11 and 12.

The invention relates to a lens retaining device for retaining a raw lens in a processing machine. Said processing machine has a tool mount for immobilizing the lens retaining device in a processing tool, and a workpiece mount for receiving a raw lens to be processed. The workpiece mount has a curved surface and is (preferably firmly) connected to the tool mount. An air channel extends from the tool mount to the curved surface of the workpiece mount. Furthermore, the workpiece mount has an adhesion element which at least to some extent forms the curved surface, wherein the adhesion element has adhesive properties on the curved surface.

Such a design is advantageous because a raw lens can be immobilized during processing, particularly with mechanical tools, by means of a vacuum in the air channel and the curved surface and, additionally, by means of the adhesion element. The function of the air channel is that of generating a suction force between the curved surface and a raw lens. A safety-relatedly relevant immobilization can be ensured by the design according to the invention even in case of a failure of the suction circuit connected to the air channel.

Furthermore, the raw lens can transported with the lens retaining device particularly between different mechanical processing steps. The immobilization of the raw lens on the lens retaining device can, for these processing steps, be based solely on the adhesion element. For that purpose, the adhesive properties of the adhesion element should be designed strong enough to ensure that a retained raw lens does not fall off at any angular position. Preferably, the adhesive properties of the adhesion element are designed such that a retained raw lens is retained with a retention force which equals at least twice, preferably at least three times, the weight of the raw lens. Preferably, the lens retaining device has a rotational axis which intersects the curved surface in the center perpendicularly, particularly such that the curved surface is rotatable in a curved rotational surface. Thus the raw lens with the lens retaining device can be rotated during processing. Such rotation stabilizes the position of the raw lens during processing, and fewer active movements have to be performed by a tool. The tool mount should be designed coaxially to the rotational axis. Such tool mounts are also called spindle connections. The air channel can thus open out from the spindle connection, particularly centrally along the rotational axis through the spindle connection.

For a successful commercial exploitation of the lens retaining device, it would be possible to design the spindle connection as standard connection, particularly a spindle connection corresponding to a design according to DIN 58766.

In a particular embodiment of the invention, the adhesion element is a film or a mat. Thus, a particularly large surface with adhesive properties can be provided. Preferably, the adhesion element forms the entire curved surface, thus maximizing the adhesive surface. The air channel should then open out through a hole in the adhesion element. In addition, the adhesion element protects the surface not to be processed and/or the receiving side of the raw lens from scratches because the adhesion element is preferably made from a softer material than the tool mount.

Basically, it is possible to coat the adhesion element on the curved surface with an adhesive. However, a preferred version of the invention provides for the adhesion element to consist of an adhesive material. As a result, the structure of the lens retaining device is simple.

Preferably, the adhesion element is an adhesion film or an adhesive mat. An adhesion film can be produced in a simple manner by cutting a length of adhesive material. An adhesive mat is particularly advantageous because it provides the option of a three-dimensional design, which, among others, can include a preforming which corresponds to the curved surface, thus preventing stresses and folding during assembly. Furthermore, an adhesive mat can be provided with finer structures, such as grooves in the curved surface, in order to evenly generate the vacuum across the curved surface. For example, the adhesion element can have grooves particularly on the curved surface, wherein the grooves are connected to the air channel. The grooves can have a groove floor which is formed by an underlying component which carries the adhesion element. However, for assembly purposes, particularly handling, it is preferred to provide possible grooves with a groove floor which is formed by the adhesion element.

In accordance with a version according to the invention, the adhesive properties of the adhesion element are caused by van der Waals forces. With such a design, the adhesive effect occurs particularly quickly, for example, when a raw lens is pressed onto the adhesion element. No curing is required. Moreover, a connection based on van der Waals forces can be usually undone residue-free. Thus, no protective layer or protective film on the raw lens is required.

A particular embodiment of the invention provides for the adhesion element to be based on polyvinyl chloride, polyethylene, or silicone (particularly poly(organo)siloxanes). Representatives of these materials have sufficiently high adhesive properties with regard to raw lenses made of glass or plastic. Furthermore, they can be removed from the raw lenses residue-free.

A further particular embodiment of the invention provides for the adhesion element to be replaceable. For such purpose, the attachment of the adhesion element on the rest of the lens retaining device should be mechanically or chemically detachable. Attachments with adhesive, for example, can be removed with acetone.

In a particular design of the invention, the adhesion element has a material thickness from 0.5 mm to 1.5 mm, preferably a material thickness from 0.7 mm to 1.3 mm, and particularly preferred from 0.9 mm to 1.1 mm. Not included are regions with possible groove in the adhesion element. As a result, the thickness of the adhesion element is sufficient to adjust to the curvature of a raw lens, particularly through elastic deforming and in the micrometer range. At the same time, the material is so thin that a stable mounting with only minute elastic movements between the lens retaining device and the raw lens is ensured.

In an embodiment of the adhesion element as film, the material thickness is constant with the exception of the region with possible grooves. A mat can also be designed with thicker and thinner regions.

For receiving raw lenses for producing spectacle glasses, it is possible to design the curved surface spherically because this is the preferred shaping of a surface not to be processed of such raw lenses. Particularly, the curved surface should be adapted for a standard CX curve of a raw lens for the prescription production of spectacle glasses. Furthermore, since the concave lens surface of these raw lenses is usually to be processed, the curved surface of the workpiece mount is preferably concave.

Moreover, a particular embodiment of the invention provides for the workpiece mount to have a carrier element which is designed integrally, preferably monolithically, with the tool mount and which carries the adhesion element. As a result, the lens retaining device has very few components and is cost-effective. The adhesion element is thus connected to the carrier element. An adhesive connection is recommended. Suitable materials for the carrier element and/or the tool mount are plastics or metals. At least the tool mount and/or the carrier element should be made of a harder material than the adhesion element.

In order to allow for satisfactory processing up to the edge region of a raw lens, the lens retaining device should have a smaller diameter than a raw lens to be retained.

Furthermore, the invention relates to a method for processing raw lenses with a lens retaining device as described above, wherein a raw lens is initially pressed against the curved surface. The raw lens should be centered relative to the lens retaining device. The raw lens is subsequently immobilized on the lens retaining device during mechanical processing by means of the adhesive properties of the adhesion element and by generating a vacuum in the air channel and between the curved surface and the raw lens. Prior or after such mechanical processing, a work step (preferably without mechanical processing) is executed, wherein the raw lens is retained solely by means of the adhesive properties of the adhesion element. Such a work step, for example, can be a waiting period or a transport between two tools. As a result, the method is particularly simple to execute because it is possible to interrupt a generating of vacuum between different processing steps.

An addition the method provides for the raw lens to be released from the lens retaining device by means of applying vibrations, blows and/or pressurization is for overcoming the adhesive bond with the adhesion element. According to the invention, such release is particularly quick and residue-free. Thus, no subsequent processing is required on the side of the raw lens not to be processed.

Furthermore, a particular version of the invention provides for a repetition of the previously described method steps, preferably with different raw lenses, and a replacement of the adhesion element is required, at the earliest, after ten, preferably at the earliest after one hundred repetitions. As a result, little waste is generated per processed raw lens due to the retaining with the lens retaining device.

Further features, details, and advantages of the invention can be derived from the claims and the following description of embodiments using the drawing.

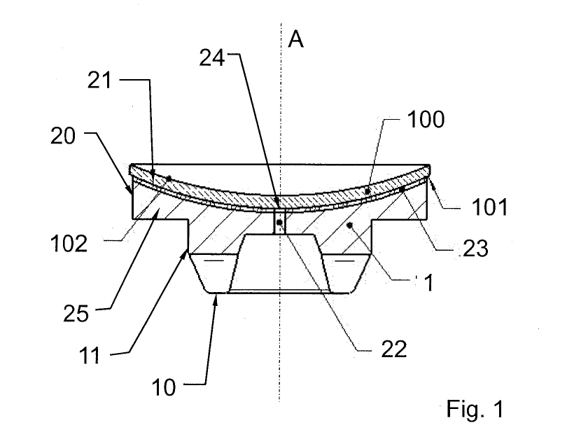

FIG. 1 shows a lens retaining device with retained raw lens.

FIG. 1 shows a lens retaining device 1 which retains a raw lens 100. The lens retaining device 1 has a tool mount 10 for immobilizing the lens retaining device 1 in a processing tool. The tool mount 10 is designed coaxially to the rotational axis A, particularly also rotationally symmetrical around the rotational axis A. It can be seen that the tool mount 10 is a spindle connection 11. The radial exterior wall of the spindle connection consists of a cylindrical section and a conical lead-in chamfer. The front face of the spindle connection 11 has a frustoconical indentation.

Said spindle connection 11 can be attached with a standard receiving element of a processing machine, particularly if said standard receiving element corresponds to a design according to DIN 58766.

Furthermore, the lens retaining device 1 has a workpiece mount 20 for receiving the raw lens 100 to be processed. The workpiece mount 20 comprises a carrier element 25 and an adhesion element 23. The carrier element 25 is designed integrally, preferably monolithically, with the tool mount 10 and carries the adhesion element 23. Suitable materials for said integrally designed component consisting of tool mount 10 and carrier element 23 are plastics or metals.

For receiving the adhesion element 23, the carrier element 25 is designed plate- or bowl-shaped and is connected with one side to the tool mount 10, wherein the carrier element 25 is also designed rotationally symmetrical with regard to the rotational axis A. Furthermore, the carrier element 25 has a greater diameter than the tool mount 10.

On the free side, i.e., the plate surface, the carrier element 25 has a curved surface which is concave and spherical and adapted for a standard CX curve of a raw lens 100 for the prescription production of spectacle glasses. On said surface, the adhesion element 23 is connected to the carrier element 25, particularly adhesively. Releasing the adherence, e.g. through chemical removal, for which acetone, for example, is suitable, depending on the adhesive agent, allows for the adhesion element 23 to be replaced in case of wear.

The adhesion element 23 is designed as an adhesion film, having a constant material thickness of preferably 0.5 mm to 1.5 mm. In order to prevent stresses and folding in the adhesion element 23, such an adhesion film can be preformed prior to bonding in accordance with the curved surface of the carrier elements 25, e.g. through deep-drawing, possibly immediately during punching from a length of film.

Due to the constant material thickness, the adhesion element 23 of the workpiece mount 20 also forms a curved surface 21 which is spherical, concave and adapted for a standard CX curve of a raw lens 100 for the prescription production of spectacle glasses. The rotational axis A perpendicularly intersects the curved surface 21 in the center, particularly such that the curved surface 21 is rotatable in a curved rotational surface.

It can be seen that the film-like adhesion element 23 forms the entire curved surface 21. For that purpose, the adhesion element 23 and the carrier element 25 have the same radial diameter.

On its curved surface 21, the adhesion element 23 has adhesive properties. For such purpose, the adhesion element 23 is made of an adhesive material, the adhesive properties of which are caused by van der Waals forces. Materials, particularly compounds based on polyvinyl chloride (PVC), polyethylene (PE), or silicone (particularly poly(organo)siloxanes) are suitable. Thus, the tool mount 10 and the carrier element 25 are made of a harder material than the adhesion element 23. In addition, the adhesion element 23 is elastically formable such that it adapts to the surface curvature of a raw lens 100, at least in the micrometer range.

The adhesive properties of the adhesion element 23 are strong enough to ensure that a retained raw lens 100 does not fall off at any angular position. Preferably, the adhesive properties of the adhesion element 23 are designed such that a retained raw lens 100 is retained with a retention force which equals at least twice, preferably at least three times, the weight of the raw lens.

Furthermore, an air channel 22 is shown which extends from the tool mount 10 to the curved surface 21 of the workpiece mount 20. Particularly, it opens into the conical indentation in the front face of the tool mount 10 along the rotational axis A. On the opposite side, the air channel 22 opens through a (small) hole 24 through the adhesion element 23 and into the curved surface 21. A spindle tool can thus generate suction in the air channel 22 which can generate a vacuum below the received raw lens 100.

Furthermore, FIG. 1 shows the received raw lens 100. With a receiving side 101, the raw lens 100 bears against the curved surface 21 of the workpiece mount 20. The optical axis of the raw lens is aligned coaxially to the rotational axis A of the lens retaining device 1. According to the design of the lens retaining device 1, the receiving side 101 is a convex surface which, particularly, is a CX surface of a lens blank for the production of spectacle glasses. The receiving side 101 already has a mechanically finished optical quality.

The receiving side 101 is opposite a processing side 102 of the raw lens 100. Said processing side 102 is concave and, through mechanical processing, can be developed into a so-called (individual) prescription surface.

It can be seen that the lens retaining device 1, particularly the carrier element 25 and the adhesion element 23 do not radially protrude beyond the raw lens 100. For this purpose, the carrier element 25 and the adhesion element 23 each have a smaller diameter than the raw lens 100. Thus, the processing side 102 can be processed up to its edge.

The invention is not limited to one of the previously described embodiments but can be designed in many different ways.

Particularly, additional grooves can be provided in the curved surface which are connected to the hole 24. This allows for the extensive and even distribution of a generated vacuum. This is particularly helpful with large raw lenses. For example, the grooves are designed sunbeam-shaped, star-shaped, or annular with distribution channels around the hole 24.

Any and all features and advantages described in the claims, the description, and the drawing, including constructive details, spatial arrangements, and method steps, can be essential features of the invention both on their own and in the different combinations.

### LIST OF REFERENCE SIGNS

| | |
|---|---|
| 1 | Lens retaining device |
| 10 | Tool mount |
| 11 | Spindle connection |
| 20 | Workpiece mount |
| 21 | Curved surface |
| 22 | Air channel |
| 23 | Adhesion element |
| 24 | Hole |
| 25 | Carrier element |
| 100 | Raw lens |
| 101 | Receiving side |
| 102 | Processing side |
| A | Rotational axis |

1. Lens retaining device (1) for retaining a raw lens (100) in a processing machine,
with a tool mount (10) for immobilizing the lens retaining device (1) in a processing machine, and
with a workpiece mount (20) for receiving a raw lens (100) to be processed,
wherein the workpiece mount (20) has a curved surface (21) and is connected to the tool mount (10), and
wherein an air channel (22) extends from the tool mount (10) to the curved surface (21) of the workpiece mount (20),
characterized in that,
the workpiece mount (20) has an adhesion element (23) which at least to some extent forms the curved surface (21),
wherein the adhesion element (23) has adhesive properties on the curved surface (21).

2. Lens retaining device (1) according to claim 1, characterized in that the adhesion element (23) is a film or a mat.

3. Lens retaining device (1) according to claim 1, characterized in that the adhesion element (23) is made of an adhesive material.

4. Lens retaining device (1) according to claim 1, characterized in that the adhesive properties of the adhesion elements (23) are caused by van der Waals forces.

5. Lens retaining device (1) according to claim 1, characterized in that the adhesion element (23) is replaceable.

6. Lens retaining device (1) according to claim 1, characterized in that the adhesion element (23) has a material thickness from 0.5 mm to 1.5 mm.

7. Lens retaining device (1) according to claim 1, characterized in that the curved surface (21) is spherical.

8. Lens retaining device (1) according to claim 1, characterized in that the curved surface (21) is concave.

9. Lens retaining device (1) according to claim 1, characterized in that the workpiece mount (20) has a carrier element (25) which is designed integrally with the tool mount (10) and which carries the adhesion element (23).

10. Method for processing raw lenses (100) with a lens retaining device (1) according to claim 1, wherein the following steps are executed:
a) Pressing of a raw lens (100) onto the curved surface (21);
b) Immobilization of the raw lens (100) on the lens retaining device (1) during a mechanical processing by means of the adhesive properties of the adhesion element (23), and by generating a vacuum in the air channel (22) and between the curved surface (21) and the raw lens (100);
c) Execution of a work step, wherein the raw lens (100) is retained solely by the adhesive properties of the adhesion element (23).

11. Method according to claim 10, characterized by the following step:
d) Removal of the raw lens (100) from the lens retaining device (1) by means of applying vibrations, blows and/or pressurization for overcoming the adhesive bond with the adhesion element (23).

12. Method according to claim 11, characterized by the following steps:
e) Repetition of the steps (a)-(d);
f) Replacement of the adhesion element (23), at the earliest, after ten repetitions.
